(19) United States
(12) Patent Application Publication
(10) Pub. No.: US 2018/0240252 A1
(43) Pub. Date: Aug. 23, 2018

(54) ROTATION CONTROL METHOD FOR DISPLAY APPARATUS

(71) Applicants: HKC Corporation Limited; Chongqing HKC Optoelectronics Technology Co., Ltd.

(72) Inventor: Chia-Hang LEE, Chongqing (CN)

(21) Appl. No.: 15/556,234

(22) PCT Filed: Jul. 7, 2017
(86) PCT No.: PCT/CN2017/092144

§ 371 Date: Sep. 6, 2017

(30) Foreign Application Priority Data
Dec. 31, 2016 (CN) 201611268144.0

(51) Int. Cl. G06T 7/73; G06F 3/01; G09G 3/20; G06F 3/147

(52) U.S. Cl. CPC G06T 7/74; G06F 3/012; G09G 2380/02; G06F 3/147; G09G 3/2096

(57) ABSTRACT

The present disclosure relates to a rotation control method for a display apparatus, including: sensing a user image by using a user position information sensing unit, to obtain user position information; performing a calculation by using a rotation angle calculation component according to the user position information, to obtain angle information, and transmitting the angle information to a motor control unit; controlling a rotation mechanism by using the motor control unit according to the angle information, where the rotation mechanism is pivotally connected to a display panel; and rotating the display panel by using the rotation mechanism.

### BACKGROUND

### Technical Field

The present disclosure relates to a display apparatus, and in particular, to a display apparatus and a method for controlling a rotation angle thereof.

### Related Art

With the development of display technologies, not only the size and the image quality of display devices have been improved, but also display devices of various shapes, for example, curved display devices, have been developed. Compared with a flat panel display device, the curved display device not only can be fabricated into a larger size in the case of a given width, but also can provide a better viewing effect. Using a flat panel television and a curved television as an example, as the sight line of a viewer moves from the center of the screen of the flat panel television toward two sides, the viewer usually has a poor visual experience at the edge of the flat panel television. Especially, for conventional flat panel liquid crystal display (either vertical alignment (VA) type or in-plane switching (IPS) type) televisions, there is usually a color difference when viewed from a large viewing angle, and the image quality becomes poorer as the viewing angle increases. In contrast, because the curved television is of an arc-shaped design, the image distortion at the edge of the screen is alleviated, and the immersive visual experience can be improved.

### SUMMARY

To resolve the foregoing technical problems, an objective of the present disclosure is to provide a rotation control method for a display apparatus, comprising: sensing a user image by using a user position information sensing unit, to obtain a user position information; performing a calculation by using a rotation angle calculation component according to the user position information, to obtain an angle information, and transmitting the angle information to a motor control unit; controlling a rotation mechanism by using the motor control unit according to the angle information, where the rotation mechanism is pivotally connected to a display panel; and rotating the display panel by using the rotation mechanism.

In some embodiments, the motor control unit comprises a motor, the rotation mechanism comprises a gear, and the motor is connected to the gear.

In some embodiments, the motor control unit comprises a rotating motor, the rotation mechanism is a rotating shaft, the rotating motor is pivotally connected to the rotating shaft, and the rotating shaft is pivotally connected to the display panel.

In some embodiments, the angle information is a deviation angle position of a user from a central plane of the display panel.

In some embodiments, after receiving the angle information provided by the rotation angle calculation component, the motor control unit converts the angle information to a relative rotation physical quantity, and controls the rotation mechanism according to the relative rotation physical quantity.

In some embodiments, the user position information sensing unit comprises a signal processor for analyzing a deviation distance of a user from a center of the display panel.

Another objective of the present disclosure is to provide a display apparatus, including: a display panel; a user position information sensing unit including an image sensor and electrically coupled to a motor control unit, used for sensing a user image, to obtain a user position information; and an angle adjustment module connected to the display panel, used for adjusting a rotation angle of the display panel according to the user position information.

Another objective of the present disclosure is to provide a display apparatus, including a display panel; a user position information sensing unit including an image sensor and electrically coupled to a motor control unit, used for sensing a user image, to obtain a user position information, where the user position information sensing unit includes a rotation angle calculation component for automatically analyzing an angle information, and the angle information is a deviation angle position of a user from a central plane of the display panel; and an angle adjustment module connected to the display panel, used for adjusting a rotation angle of the display panel according to the user position information, where the angle adjustment module includes a rotation control mechanism unit including a gear, and the motor control unit including a motor, where the motor is connected to the gear. After receiving the angle information provided by the rotation angle calculation component, the motor control unit converts the angle information to a relative rotation physical quantity, and controls the motor according to the relative rotation physical quantity.

Another objective of the present disclosure is to provide a curved display apparatus, including a curved display panel, and an angle adjustment module connected to the curved display panel and used for adjusting a rotation angle of the display panel.

The objectives of the present disclosure and solutions to the technical problems thereof may be further implemented by using the following technical solutions.

An intelligent method for controlling a rotation angle of a curved display apparatus corresponding to another objective of the present disclosure includes: providing the curved display apparatus; sensing a position information of an object image by using the user position information sensing unit, to generate a control signal; controlling, according to the control signal, the motor of the motor control unit to rotate; and controlling the rotation angle of the display panel by means of a rotation degree of the rotation control mechanism unit.

In an embodiment of the present disclosure, the display panel includes: a cover plate including a first curved surface, and a back plate disposed opposite to the cover plate and including a second curved surface.

In an embodiment of the present disclosure, the display panel further includes a liquid crystal display (LCD) panel, disposed between the back plate and the cover plate.

In an embodiment of the present disclosure, the angle adjustment module includes: a rotation control mechanism unit including a gear; a motor control unit including a motor, where the motor is connected to the gear; and a user position information sensing unit including a charge coupled component and electrically coupled to the motor control unit, used for sensing an object image.

In an embodiment of the present disclosure, the motor is a stepper motor.

In an embodiment of the present disclosure, the user position information sensing unit includes a rotation angle calculation component for automatically analyzing a deviation angle position of a user from a central plane of the display. In an embodiment of the present disclosure, the user position information sensing unit further includes a signal processor for analyzing a deviation distance of the user from a center of the display. In an embodiment of the present disclosure, in the method, the step of controlling the rotation angle of the display panel by means of a rotation degree of the rotation control mechanism unit includes: connecting the back plate of the display panel by using the rotation control mechanism unit; adjusting the second curved surface of the back plate by means of rotation of the gear; adjusting a rotation angle of the second curved surface, so that a rotation angle of the first curved surface of the cover plate is adjusted accordingly.

In an embodiment of the present disclosure, in the method, the motor is a stepper motor.

In an embodiment of the present disclosure, in the method, the user position information sensing unit may be a sensing chip or a sensor.

In some embodiments of the present disclosure, the display panel may be a curved display panel. In some embodiments of the present disclosure, the display panel may be a flat panel display panel.

According to the present disclosure, a method for controlling a rotation angle of a display can be automatically adjusted according to changes of a user position, so as to adjust a rotation angle of a display apparatus, thereby improving image quality when a viewer views the display from a large viewing angle.

### BRIEF DESCRIPTION OF THE DRAWINGS

FIG. 1a is an exemplary schematic diagram of a viewing angle of a television;

FIG. 1b is an exemplary schematic diagram of vertical and horizontal color differences;

FIG. 2a is an exemplary schematic diagram of a gamma curve of a pixel;

FIG. 2b is an exemplary schematic diagram of controlling a gamma curve of a pixel by using a voltage;

FIG. 3 is an exemplary schematic diagram of a relationship between different viewing angles of a user viewing a display and different distances between the user and the display;

FIG. 4 is another exemplary schematic diagram of a relationship between different viewing angles of a user viewing a display and different distances between the user and the display;

FIG. 5 is a schematic diagram of a display apparatus according to an embodiment of the present disclosure;

FIG. 6 is a flowchart of a method for controlling a rotation angle of a display apparatus according to an embodiment of the present disclosure;

FIG. 7 is a schematic diagram of sensing a user position by using a user position information sensing unit according to an embodiment of the present disclosure;

FIG. 8 is a schematic diagram of a display apparatus according to another embodiment of the present disclosure;

FIG. 9 is a schematic diagram of operation of a rotation control mechanism unit according to an embodiment of the present disclosure;

FIG. 10 is a schematic diagram of operation of a display apparatus according to an embodiment of the present disclosure; and

FIG. 11 is a schematic diagram of a display apparatus according to an embodiment of the present disclosure.

### DETAILED DESCRIPTION

The following embodiments are described with reference to the accompanying drawings, and are intended to exemplify specific embodiments of the present disclosure for implementation. Terms about directions mentioned in the present disclosure, for example, “on”, “below”, “front”, “back”, “left”, “right”, “inside”, “outside”, and “side” merely refer to directions in the accompanying drawings. Therefore, the used terms about directions are intended to describe and understand the present disclosure, rather than to limit the present disclosure.

The accompanying drawings and the descriptions are considered to be essentially exemplary, rather than limitative. In the figures, units with similar structures are represented by using the same reference numerals. In addition, for understanding and ease of description, the size and the thickness of each component shown in the accompanying drawings are arbitrarily shown. However, the present disclosure is not limited thereto.

In the accompanying drawings, for clarity, the thicknesses of a layer, a film, a panel, an area, and the like are exaggerated. In the accompanying drawings, for understanding and ease of description, the thicknesses of some layers and areas are exaggerated. It should be understood that when a component such as a layer, a film, an area, or a base is described to be “on” “another component”, the component may be directly on the another component, or there may be an intermediate component.

In addition, in this specification, unless explicitly described to have an opposite meaning, the term “include” is understood as including the component, but not excluding any other component. In addition, in this specification, “on” means that a component is located on or below a target component, but does not mean that the component needs to be located on the top based on the direction of gravity.

To further describe the technical measures and functions used by the present disclosure to achieve the predetermined disclosure objectives, a rotation control method for a display apparatus according to the present disclosure and specific implementations, structures, features, and functions of the display apparatus are described below in detail with reference to the accompanying drawings and preferred embodiments.

A display device of the present disclosure includes a liquid crystal display (LCD) panel and a backlight module disposed opposite to each other. The LCD panel mainly includes a color filter substrate, a thin film transistor substrate, and a liquid crystal layer disposed between the two substrates. The color filter substrate and the thin film transistor substrate may form with the liquid crystal layer a plurality of pixel units of array configuration. The backlight module may emit light to pass through the LCD panel, and the pixel units of the LCD panel display colors to form an image.

In an embodiment, the LCD panel of the present disclosure may be a curved display panel, and the display device of the present disclosure may also be a curved display apparatus.

In some embodiments, the display panel in the present disclosure may be a flat panel display panel, that is, there is no curved display panel.

In some embodiments, the display panel of the present disclosure may be applied to different displays, for example, an LCD, an organic electro luminescence display (OEL), an organic light emission diode display (OLED), a light emission diode display (LED), a plasma display panel (PDP), a field emission display, a carbon nanotube display, an E-ink display, an interferometric modulator display, a micro-electro-mechanical display using a time multiplexed optical shutter (TMOS) technology, or a display using an electrochromic display (ECD) technology.

A curved display is a display with a curved display panel. When a viewer views a curved display, distances between the eyes of the viewer and different parts of the curved display are approximately equal. Regardless of images displayed in a central area or left and right edge areas may be viewed by the viewer from a viewing angle of an approximate right angle. Therefore, compared with a flat panel display, the curved display does not cause problems such as luminance deviation and color deviation when viewed from a large viewing angle. In addition, the curved display has a nearly three-dimensional visual effect. Therefore, the curved display has been a display product attracting much attention. However, since the curved display is formed by bending the flat panel display panel with an external force, a relative position deviation is produced between two substrates, causing a problem of light leakage, and affecting display quality of the curved display.

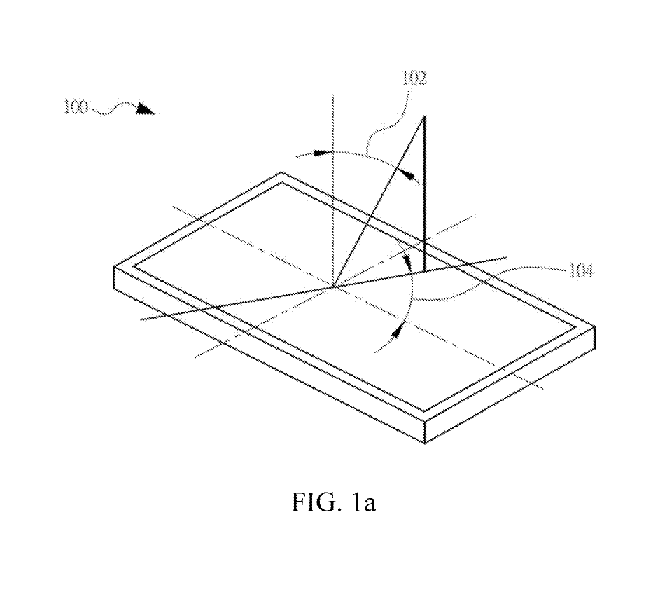

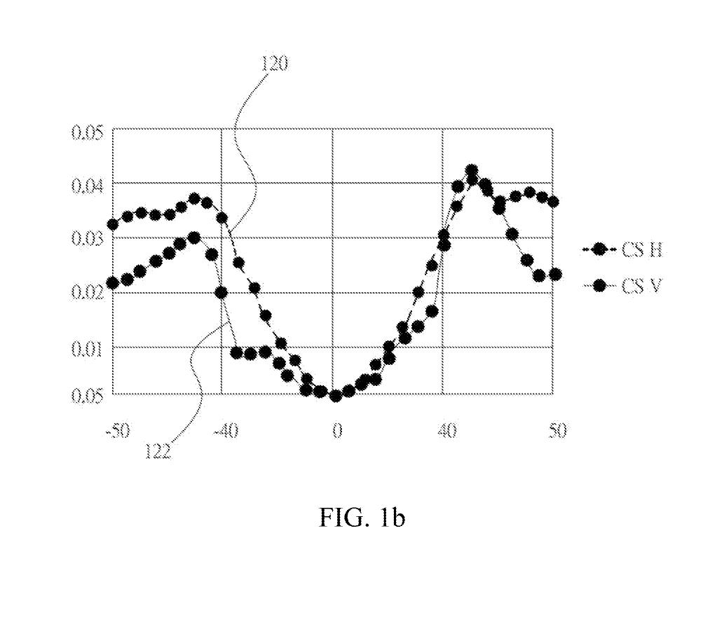

FIG. 1a is an exemplary schematic diagram of a viewing angle of a television, and FIG. 1b is an exemplary schematic diagram of vertical and horizontal color differences. Referring to FIG. 1a and FIG. 1b, currently, more and more televisions adopt a curved design not only because of a novel appearance design, but also because of outstanding television image quality. Especially, for conventional flat panel LCD 100 televisions, either of a vertical alignment (VA) type or an in-plane switching (IPS) type, there are usually a horizontal color difference 120 and a vertical color difference 122 with a normal angle 102 and a horizontal angle 104 of a central viewing angle when viewed from a large viewing angle, and the image quality becomes poorer as the viewing angle increases.

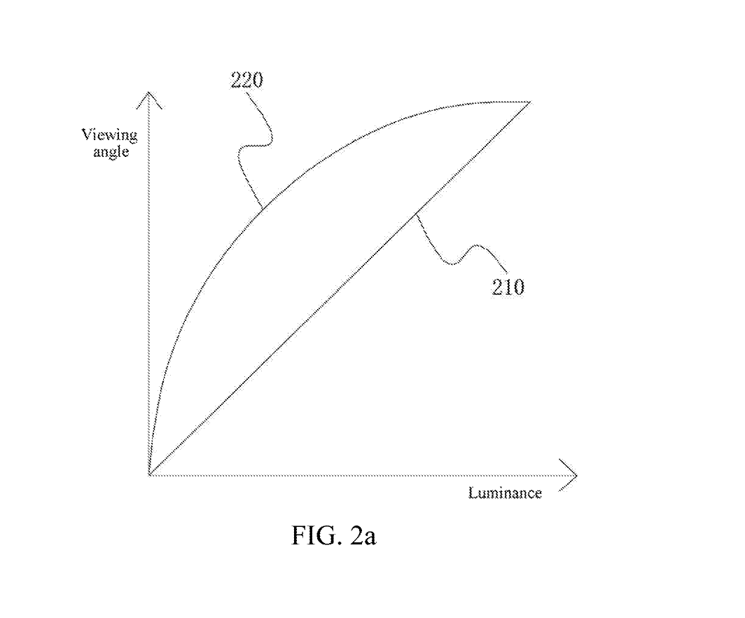

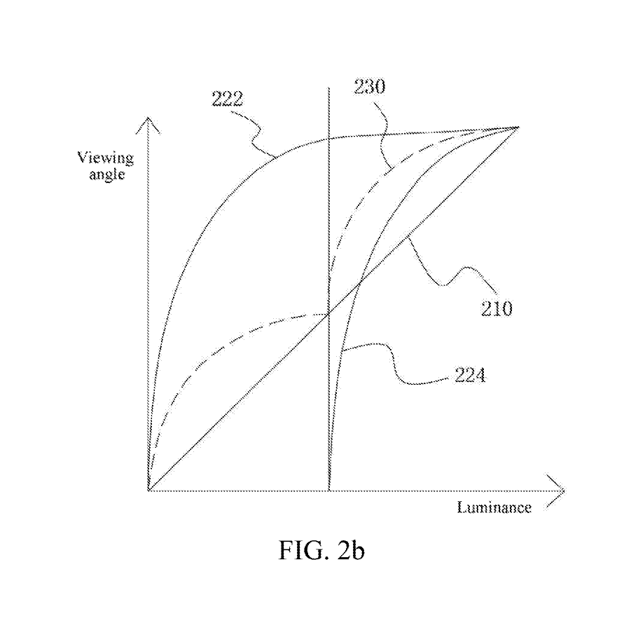

FIG. 2a is an exemplary schematic diagram of a gamma curve of a pixel, and FIG. 2b is an exemplary schematic diagram of controlling a gamma curve of a pixel by using a voltage. Referring to FIG. 2a and FIG. 2b, a conventional manner for improving a viewing angle of a flat panel LCD is to split one pixel into two subpixels, namely a subpixel A and a subpixel B; control a gamma curve 222 of the subpixel A and a gamma curve 224 of the subpixel B by using a voltage; and combine the gamma curve 222 of the subpixel A and the gamma curve 224 of the subpixel B to form a gamma curve 230, to approximate an ideal gamma curve 210, so as to compensate for and reduce a color difference of a side viewing angle. Such a method is referred to as a spatial pixel compensation method.

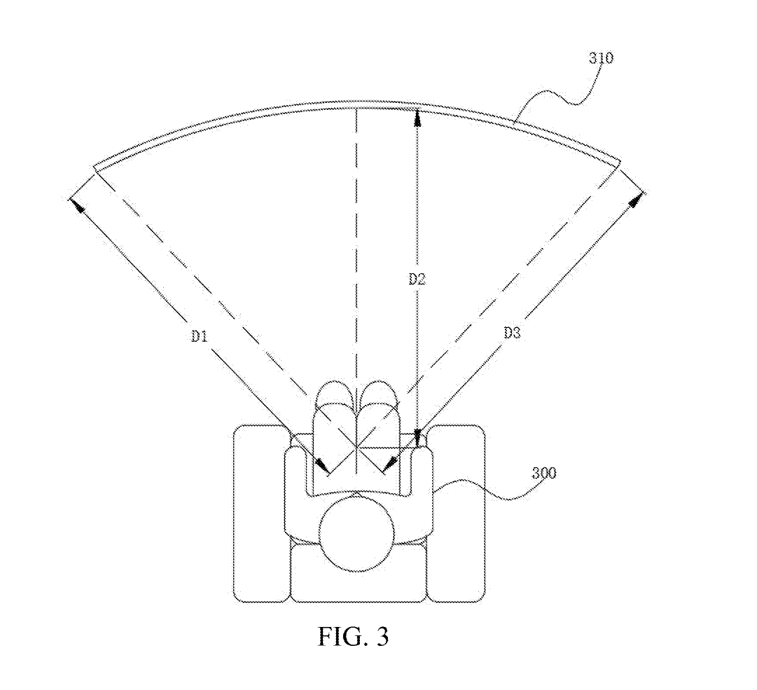

FIG. 3 is an exemplary schematic diagram of a relationship between different viewing angles of a user 300 viewing a display 310 and different distances between the user 300 and the display 310. Referring to FIG. 3, when a user views a flat panel display, a distance between a center of a display image of the flat panel display and the user is not equal to distances between two sides of the display image and the user, causing distortion of an image viewed by the user. Therefore, the curved display 310 is put forward. When the user 300 views the curved display 310, because a distance between a center of a display image of the curved display 310 and the user 300 is close to distances between two sides of the display image of the curved display 310 and the user 300, the image viewed by the viewer 300 is more realistic, and viewing fatigue is reduced. Therefore, another method for improving image quality of a viewing angle is to adopt a curved display design. That is, for specified viewing distances D1, D2, and D3, a corresponding curvature of the display is calculated. Generally, the curvature of the display is approximately R2000, and the curvature of a television is set to approximately R4000. As shown in FIG. 3, it can be seen that under a proper curvature and viewing distances D1, D2, and D3, each viewing angle of the display 310 is same as the center viewing angle, thereby alleviating image distortion of a screen caused by different viewing angles.

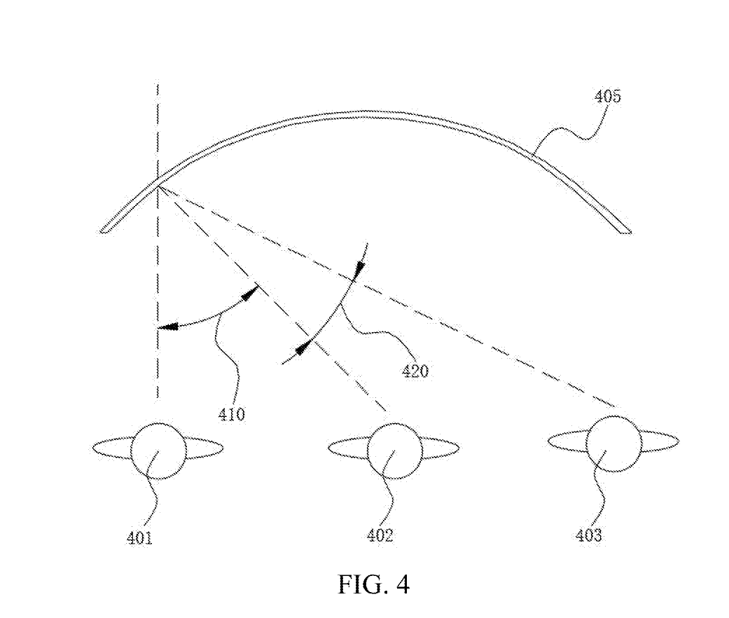

FIG. 4 is another exemplary schematic diagram of a relationship between different viewing angles of users 401, 402, and 403 viewing a display 405 and different distances between the users 401, 402, and 403 and the display 405. Referring to FIG. 4, conventionally, the curved display 405 is designed for a single viewer 402 at a coordinate position of a center axis (that is, a center position). However, as shown in FIG. 4, usually, when a television 405 is viewed, the television 405 is likely to be viewed by more than one viewer 401, 402, and 403, and is not always viewed by a viewer at the center position. Therefore, conditions for optimum viewing angles 410 and 420 easily change with different positions of the viewers 401, 402, and 403, and consequently optimum image quality cannot be obtained.

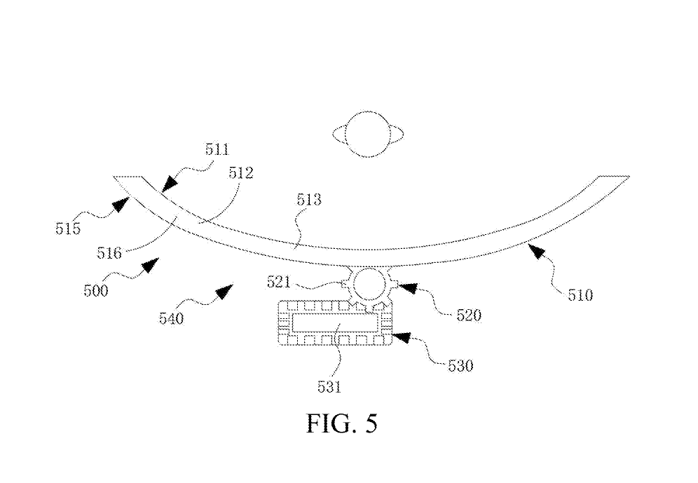

FIG. 5 is a schematic diagram of a curved display apparatus 500 according to an embodiment of the present disclosure. Referring to FIG. 5, in an embodiment of the present disclosure, a curved display apparatus 500 includes a display panel 510 and an angle adjustment module 540. The display panel 510 includes: a cover plate 511 including a first curved surface 512, a back plate 515 disposed opposite to the cover plate 511 and including a second surface 516, and an LCD panel 513 disposed between the back plate 515 and the cover plate 511. The angle adjustment module 540, connected to the display panel 510 and used for adjusting a rotation angle of the display panel 510, includes: a rotation control mechanism unit 520 including a gear 521, and a motor control unit 530 including a motor 531, where the motor 531 is connected to the gear 521.

In an embodiment, the motor 531 of the present disclosure is a stepper motor.

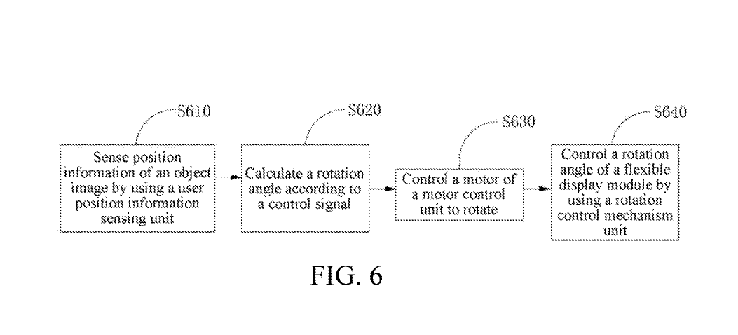

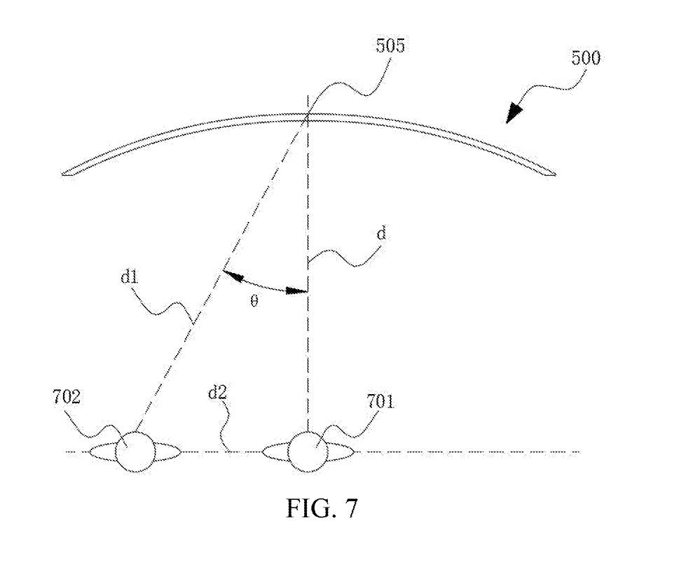

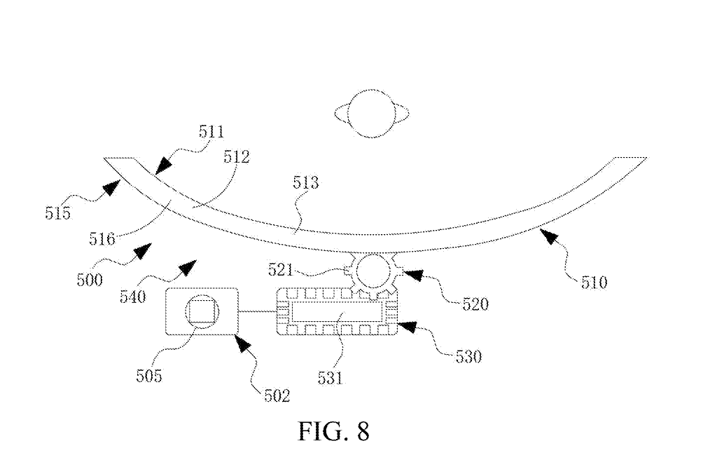

FIG. 6 is a flowchart of a method for controlling a rotation angle of a curved display apparatus 500 according to an embodiment of the present disclosure, FIG. 7 is a schematic diagram of sensing positions of users 701 and 702 by using a user position information sensing unit 502 according to an embodiment of the present disclosure, and FIG. 8 is a schematic diagram of a curved display apparatus 500 according to another embodiment of the present disclosure. Referring to FIG. 6, FIG. 7, and FIG. 8, in an embodiment of the present disclosure, a curved display apparatus 500 includes a display panel 510 and an angle adjustment module 540. The display panel 510 includes: a cover plate 511 including a first curved surface 512, a back plate 515 disposed opposite to the cover plate 511 and including a second surface 516, and an LCD panel 513 disposed between the back plate 515 and the cover plate 511. The angle adjustment module 540, connected to the display panel 510 and used for adjusting a rotation angle of the display panel 510, includes: a rotation control mechanism unit 520 including a gear 521; a motor control unit 530 including a motor 531, where the motor 531 is connected to the gear 521; and a user position information sensing unit 502 including a charge coupled component 505 and electrically coupled to the motor control unit 530, used for sensing an object image.

In an embodiment, the user position information sensing unit 502 of the present disclosure includes a rotation angle calculation component for automatically analyzing a deviation angle position of users 701 and 702 from a central plane of a display, where tan( )=d2/d.

In an embodiment, the user position information sensing unit 502 of the present disclosure further includes a signal processor for analyzing a deviation distance d2 of the users 701 and 702 from a center of the display.

In an embodiment, the user position information sensing unit 502 of the present disclosure may preload a preset distance d between a display panel 505 and the user 701, and a distance d1 between the display panel 505 and the user 702.

In an embodiment, the motor 531 of the present disclosure is a stepper motor.

In an embodiment, the user position information sensing unit 502 of the present disclosure may be a sensing chip or a sensor.

Referring to FIG. 6 and FIG. 8, in an embodiment of the present disclosure, a method for controlling a rotation angle of a display apparatus 500 includes the following blocks: providing the curved display apparatus 500; S610: sensing a position information of an object image by using the user position information sensing unit 502, to generate a control signal; S620: calculating a rotation angle according to the control signal: S630: controlling a motor 531 of a motor control unit 530 to rotate; and S640: controlling a rotation angle of a flexible display module 510 by using a rotation control mechanism unit 520.

It should be understood that in some embodiments, the foregoing method may be implemented in a computing device by a processor, for example, by running an application. However, it should be noted that unless otherwise described, the foregoing method does not need to be performed according to the exact order shown in the figure. In addition, a plurality of similar blocks may be implemented in parallel, rather than in order. Therefore, elements of the foregoing method are referred to as “blocks” rather than “steps” in this specification. It should further be understood that the foregoing method may also be implemented on variations of the computing device.

It may be further understood that the method of the present invention may be implemented in a display apparatus. However, the method of the present invention may further be implemented in a similar apparatus or system having components similar to the display apparatus but disposed in different configuration.

In an embodiment, in the method of the present disclosure, the step of controlling the rotation angle of the display panel 510 by means of a rotation degree of the rotation control mechanism unit 520 includes: connecting the back plate 515 of the display panel 510 by using the rotation control mechanism unit 520; adjusting the second curved surface 516 of the back plate 515 by means of rotation of the gear 521; adjusting a rotation angle of the second curved surface 516, so that a rotation angle of the first curved surface 512 of the cover plate 511 is adjusted accordingly.

In an embodiment, in the method of the present disclosure, the motor 531 is a stepper motor.

In an embodiment, in the method of the present disclosure, a curvature calculation unit 502 may be a sensing chip or a sensor.

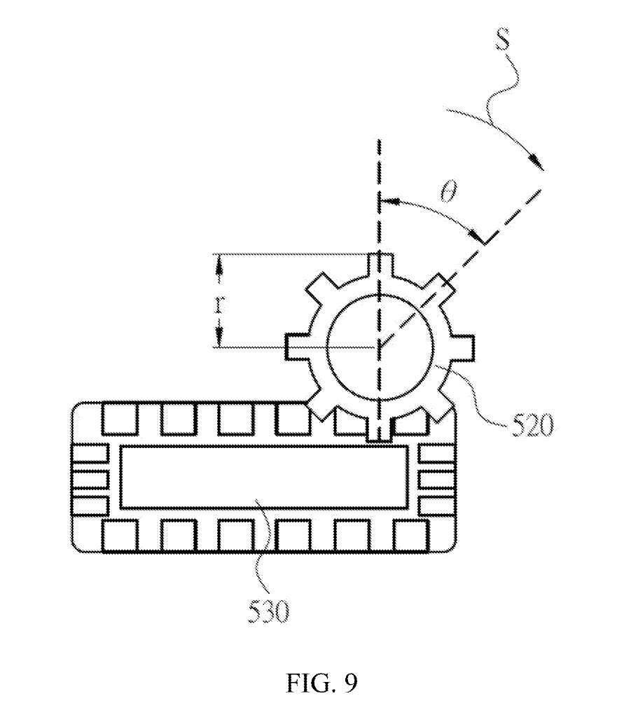

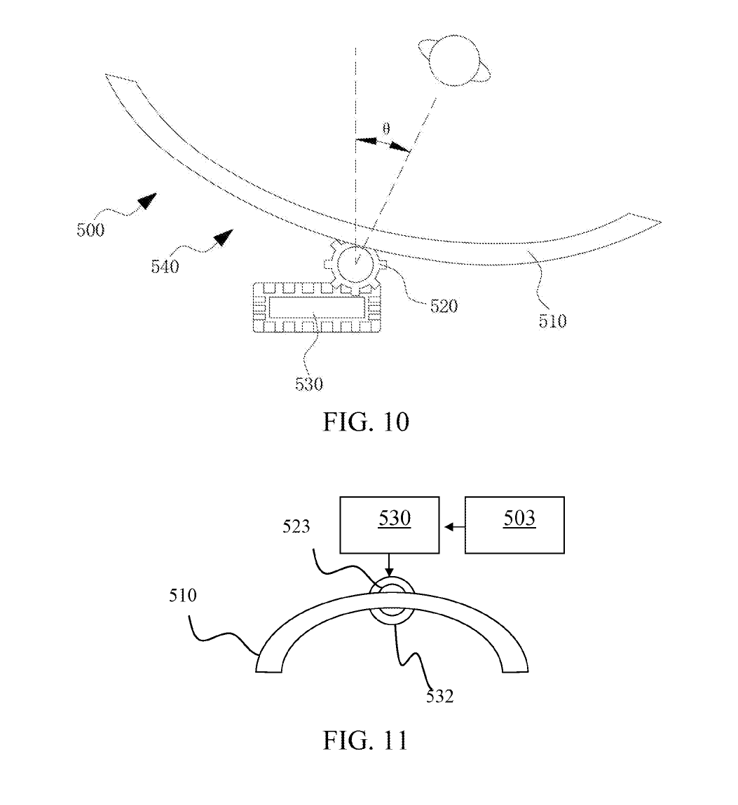

FIG. 9 is a schematic diagram of operation of a rotation control mechanism unit 520 according to an embodiment of the present disclosure, and FIG. 10 is a schematic diagram of operation of a display apparatus 500 according to an embodiment of the present disclosure. Referring to FIG. 7, FIG. 8, FIG. 9, and FIG. 10, in an embodiment of the present disclosure, a display apparatus 500 includes a display panel 510 and an angle adjustment module 540. The display panel 510 includes: a cover plate 511 including a first curved surface 512, a back plate 515 disposed opposite to the cover plate 511 and including a second surface 516, and an LCD panel 513 disposed between the back plate 515 and the cover plate 511. The angle adjustment module 540, connected to the display panel 510 and used for adjusting a rotation angle of the display panel 510, includes: a rotation control mechanism unit 520 including a gear 521; a motor control unit 530 including a motor 531, where the motor 531 is connected to the gear 521; and a user position information sensing unit 502 including a charge coupled component 505 and electrically coupled to the motor control unit 530, used for sensing an object image.

In an embodiment, the user position information sensing unit 502 of the present disclosure includes a rotation angle calculation component 503, electrically connected to the motor control unit 530 through a transmission interface, to control a required rotation angle θ of the motor 531.

In an embodiment, after receiving the angle information provided by the rotation angle calculation component, the motor control unit 530 of the present disclosure converts the angle information to a relative rotation physical quantity S (r×θ) (the relative rotation physical quantity=a gear radius×a deviation angle position of a user from a central plane of the display panel), and controls the motor 53 according to the relative rotation physical quantity.

FIG. 11 is a schematic diagram of a display apparatus according to an embodiment of the present disclosure. In an embodiment of the present disclosure, the motor control unit 530 may include a rotating motor 532, the rotation mechanism may be or include a rotating shaft 523, the rotating motor 532 is pivotally connected to the rotating shaft 523, and the rotating shaft 523 is pivotally connected to the display panel 510. When controlling the display panel 510 to rotate, the rotation angle calculation component 503 may perform a calculation according to the user position information to obtain an angle information, and transmit the angle information to the motor control unit 530. The motor control unit 530 may control, according to the angle information, the rotating shaft 523 to rotate, so as to control the display panel 510 to rotate.

According to the present disclosure, a method for controlling a rotation angle of a display can be automatically adjusted according to changes of a user position, so as to adjust a rotation angle of a curved display apparatus, thereby improving image quality when a viewer views the display from a large viewing angle.

A person of ordinary skill in the art may understand that all or some of the processes of the methods in the embodiments may be implemented by a computer program instructing relevant hardware. The program may be stored in a computer readable storage medium. When the program runs, the processes of the methods in the embodiments are performed. The foregoing storage medium may include: a magnetic disk, an optical disc, a read-only memory (ROM), or a random access memory (RAM).

The terms such as “in some embodiments” and “in various embodiments” are used repeatedly. The terms usually do not refer to a same embodiment, but may refer to a same embodiment. The terms such as “comprise”, “have”, and “include” are synonyms, unless other meanings are indicated in the context.

Descriptions above are merely preferred embodiments of the present disclosure, and are by no means intended to limit the present disclosure. Although the present disclosure has been disclosed above through the preferred embodiments, the embodiments are not intended to limit the present disclosure. A person skilled in the art can make some equivalent variations, alterations, or modifications to the technical content disclosed above without departing from the scope of the technical solutions of the present disclosure to obtain equivalent embodiments. Any simple alteration, equivalent change or modification made to the above embodiments according to the technical essence of the present disclosure without departing from the content of the technical solutions of the present disclosure shall fall within the scope of the technical solutions of the present disclosure.

What is claimed is:

1. A rotation control method for a display apparatus, comprising:
sensing a user image by using a user position information sensing unit, to obtain a user position information;
performing a calculation by using a rotation angle calculation component according to the user position information, to obtain an angle information, and transmitting the angle information to a motor control unit;
controlling a rotation mechanism by using the motor control unit according to the angle information, wherein the rotation mechanism is pivotally connected to a display panel; and
rotating the display panel by using the rotation mechanism.

2. The rotation control method for a display apparatus according to claim 1, wherein the motor control unit comprises a motor, the rotation mechanism comprises a gear, and the motor is connected to the gear.

3. The rotation control method for a display apparatus according to claim 2, wherein the motor is a stepper motor.

4. The rotation control method for a display apparatus according to claim 1, wherein the motor control unit comprises a rotating motor, the rotation mechanism is a rotating shaft, the rotating motor is pivotally connected to the rotating shaft, and the rotating shaft is pivotally connected to the display panel.

5. The rotation control method for a display apparatus according to claim 1, wherein the angle information is a deviation angle position of a user from a central plane of the display panel.

6. The rotation control method for a display apparatus according to claim 4, wherein after receiving the angle information provided by the rotation angle calculation component, the motor control unit converts the angle information to a relative rotation physical quantity, and controls the rotation mechanism according to the relative rotation physical quantity.

7. The rotation control method for a display apparatus according to claim 1, wherein the user position information sensing unit comprises a signal processor for analyzing a deviation distance of a user from a center of the display panel.

8. A rotation control method for a display apparatus, comprising:
sensing a user image by using a user position information sensing unit, to obtain a user position information, wherein the user position information sensing unit comprises a signal processor for analyzing a deviation distance of a user from a center of a display panel;
performing a calculation by using a rotation angle calculation component according to the user position information, to obtain an angle information, and transmitting the angle information to a motor control unit, wherein the angle information is a deviation angle position of the user from a central plane of the display panel, and after receiving the angle information provided by the rotation angle calculation component, the motor control unit converts the angle information to a relative rotation physical quantity, and controls a rotation mechanism according to the relative rotation physical quantity;
controlling the rotation mechanism by using the motor control unit according to the angle information, wherein the rotation mechanism is pivotally connected to the display panel; and
rotating the display panel by using the rotation mechanism,
wherein the motor control unit comprises a rotating motor, the rotation mechanism is a rotating shaft, the rotating motor is pivotally connected to the rotating shaft, and the rotating shaft is pivotally connected to the display panel.
